(19) United States
(12) Patent Application Publication
(10) Pub. No.: US 2025/0007076 A1
(43) Pub. Date: Jan. 2, 2025

(54) POWER STORAGE DEVICE

(71) Applicants: Masatoshi HAYASHITA, Kariya-shi (JP); Mitsuki MAEDA, Toyota-shi (JP); Cong BAO, Ningde (CN)

(72) Inventors: Masatoshi HAYASHITA, Kariya-shi (JP); Mitsuki MAEDA, Toyota-shi (JP); Cong BAO, Ningde (CN)

(73) Assignees: TOYOTA JIDOSHA KABUSHIKI KAISHA, Toyota-shi (JP); CONTEMPORARY AMPEREX TECHNOLOGY CO., LIMITED, Ninge (CN)

(21) Appl. No.: 18/756,873

(22) Filed: Jun. 27, 2024

(30) Foreign Application Priority Data
Jun. 30, 2023 (CN) 202310799943.4

(51) Int. Cl. H01M 50/282; H01M 50/209; H01M 50/238; H01M 50/507

(52) U.S. Cl. CPC H01M 50/282; H01M 50/209; H01M 50/238; H01M 50/507

(57) ABSTRACT

A power storage device includes: a stack formed of a plurality of battery cells arrayed in an X direction (array direction); a smoke exhaust duct placed on the stack and extending in the X direction; a bus bar module including a plurality of bus bars connected to the stack; and a sponge (elastic body) placed on the smoke exhaust duct. The bus bar module covers at least a part of the smoke exhaust duct. The sponge is placed between the bus bar module and the smoke exhaust duct.

### CROSS REFERENCE TO RELATED APPLICATIONS

This nonprovisional application is based on CN202310799943.4 filed on Jun. 30, 2023 with the China National Intellectual Property Administration, the entire contents of which are hereby incorporated by reference.

### BACKGROUND

### Field

The present disclosure relates to a power storage device.

### Description of the Background Art

Japanese Patent Laying-Open No. 2015-022965 discloses a battery stack formed of a plurality of stacked battery cells. A smoke exhaust duct extending in the stacking direction is attached to the battery stack. The smoke exhaust duct is fixed by being attached to smoke exhaust duct mount rails provided on the battery stack.

### SUMMARY

The battery stack may be deformed into a wavy shape rising and falling in the top-bottom direction (the direction in which the stack and the smoke exhaust duct overlap each other), due to expansion of each of the plurality of battery cells. It is therefore desired to restrain the deformation of the stack in the top-bottom direction while restraining increase of the number of parts.

The present disclosure is made to provide a solution to the above-described problem, and an object of the present disclosure is to provide a power storage device that makes it possible to restrain deformation of a stack in the top-bottom direction (the direction in which the stack and a smoke exhaust duct overlap each other) while restraining increase of the number of parts.

### Solution to Problems

A power storage device according to one aspect of the present disclosure includes: a stack formed of a plurality of battery cells arrayed in an array direction; a smoke exhaust duct placed on the stack and extending in the array direction; a bus bar module including a plurality of bus bars connected to the stack; and an elastic body placed on the smoke exhaust duct. The bus bar module covers at least a part of the smoke exhaust duct. The elastic body is placed between the bus bar module and the smoke exhaust duct.

In the power storage device according to the one aspect of the present disclosure, the elastic body is placed between the bus bar module and the smoke exhaust duct as described above. Thus, the smoke exhaust duct can be pressed by means of the bus bar module, with the elastic body interposed therebetween. Accordingly, the stack can be restrained from being deformed in the top-bottom direction (the direction in which the stack and the smoke exhaust duct overlap each other), by the smoke exhaust duct pressed by the bus bar module. Moreover, as compared with the case where a separate member is provided for restraining the stack from being deformed, it is possible to restrain the deformation by means of the bus bar module. It is therefore possible to restrain the stack from being deformed in the top-bottom direction, while restraining increase of the number of parts.

In the power storage device according to the one aspect, the elastic body preferably includes a central elastic body placed at a position corresponding to a central portion, in the array direction, of the stack. Such a configuration makes it possible to more reliably restrict shift of battery cells that are included in the plurality of battery cells and located in a central portion in the array direction.

In the power storage device according to the one aspect, the elastic body preferably includes an end elastic body placed at an end, in the array direction, of the smoke exhaust duct. Such a configuration makes it possible to more reliably restrict shift of battery cells located at a position corresponding to an end of the smoke exhaust duct.

In the power storage device according to the one aspect, the bus bar module preferably includes a frame member supporting the plurality of bus bars. The plurality of bus bars press the frame member toward the stack. At least a part of the frame member is placed to extend on an opposite side to the stack with respect to the elastic body to cover at least a part of the smoke exhaust duct. Such a configuration makes it possible to use the force of pressing the frame member toward the stack by the bus bar so as to press the smoke exhaust duct by the at least a part of the frame member with the elastic body interposed therebetween.

In this case, the plurality of bus bars preferably include a first bus bar located on one side of the smoke exhaust duct in a crossing direction crossing the array direction, and a second bus bar located on the other side of the smoke exhaust duct in the crossing direction. The first bus bar and the second bus bar each press the frame member toward the stack. Such a configuration makes it possible to press the frame member toward the stack, on both sides of the smoke exhaust duct in the crossing direction. Thus, the smoke exhaust duct can be fixed more stably.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a configuration of a power storage device according to an embodiment.

FIG. 2 is a perspective view showing a battery cell according to an embodiment.

FIG. 3 is a partial enlarged view of a sponge and its periphery in FIG. 1.

FIG. 4 is a cross-sectional view along line IV-IV in FIG. 1.

### DESCRIPTION OF THE PREFERRED EMBODIMENTS

Embodiments of the present disclosure are described in detail hereinafter with reference to the drawings. In the drawings, the same or corresponding parts are denoted by the same reference characters, and a description thereof is not herein repeated.

One direction and the other direction along an X direction are herein referred to as X1 direction and X2 direction, respectively. One direction and the other direction along a Y direction orthogonal to the X direction are herein referred to as Y1 direction and Y2 direction, respectively. One direction and the other direction along a Z direction orthogonal to each of the X direction and the Y direction are herein referred to as Z1 direction and Z2 direction, respectively.

### <Overall Configuration>

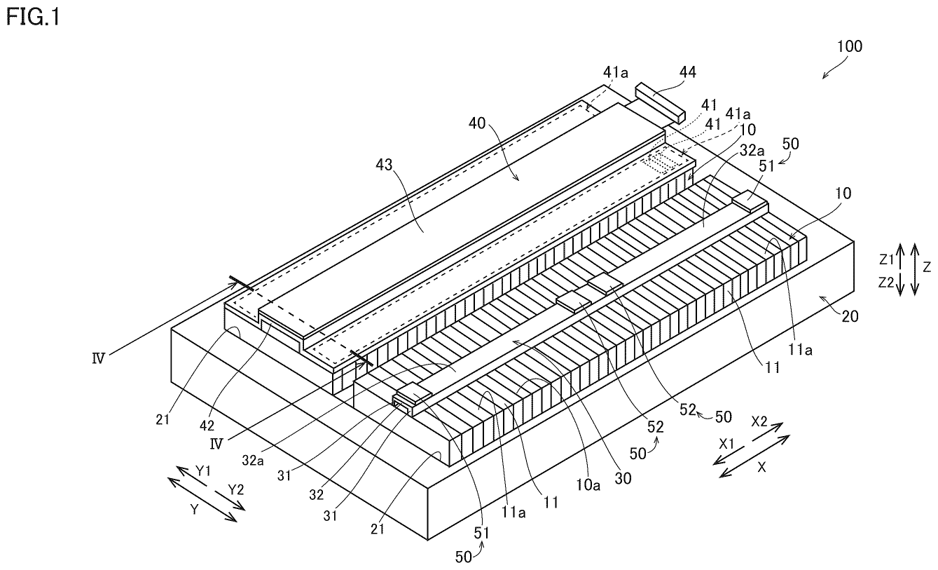

FIG. 1 is a perspective view showing the overall configuration of a power storage device 100 according to the present embodiment. Power storage device 100 is used as a power supply for driving a vehicle such as hybrid electric vehicle (HEV), plug-in hybrid electric vehicle (PHEV), or battery electric vehicle (BEV). Power storage device 100 may be used for an electrical device (stationary battery, for example) other than a vehicle.

Power storage device 100 includes a stack 10, a die-cast case 20, a smoke exhaust duct 30, a bus bar module 40, and a sponge 50. Sponge 50 is an example of “elastic body” in the present disclosure.

Stack 10 includes a plurality of battery cells 11. The plurality of battery cells 11 of stack 10 are arrayed (stacked) in the X direction. Power storage device 100 includes two stacks 10. Two stacks 10 are arranged in the Y direction orthogonal to the X direction. The X direction is an example of “array direction” in the present disclosure.

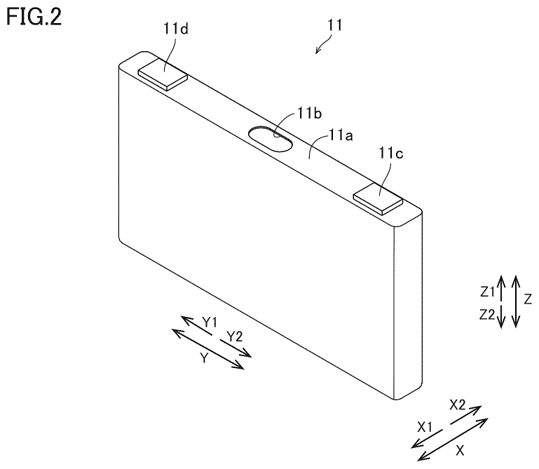

As shown in FIG. 2, an upper surface 11a, on the Z1 side, of each of the plurality of battery cells 11 is provided with a gas-discharge valve 11b, a positive electrode terminal 11c, and a negative electrode terminal 11d. Gas-discharge valve 11b is provided in a central portion, in the Y direction, of upper surface 11a. Positive electrode terminal 11c is provided at an end, on the Y2 side, of upper surface 11a. Negative electrode terminal 11d is provided at an end, on the Y1 side, of upper surface 11a.

Referring again to FIG. 1, die-cast case 20 is made of aluminum, for example. Die-cast case 20 is configured to accommodate stack 10. Specifically, die-cast case 20 is provided with two accommodation holes 21. Stack 10 is accommodated in each of two accommodation holes 21. Accommodation hole 21 holds (fixes) stack 10 in such a manner that restricts shift of stack 10 in each of the X direction and the Y direction.

Smoke exhaust duct 30 is placed on stack 10. Specifically, smoke exhaust duct 30 is placed on an upper surface 10a, on the Z1 side, of stack 10. Smoke exhaust duct 30 is not fixed (fastened, bonded, and engaged) to upper surface 10a of stack 10 by means of a jig or the like. That is, smoke exhaust duct 30 is only mounted on upper surface 10a. Upper surface 10a is a surface formed of respective upper surfaces 11a, on the Z1 side, of the plurality of battery cells 11 arrayed in the X direction.

Smoke exhaust duct 30 is placed on stack 10 and extends in the X direction. One smoke exhaust duct 30 is placed on stack 10. Smoke exhaust duct 30 is placed so as to extend from battery cell 11 at the end, on the X1 side, of stack 10 to battery cell 11 at the end, on the X2 side, of stack 10. A plurality of smoke exhaust ducts 30 arranged in the X direction may be placed on stack 10.

Smoke exhaust duct 30 has a U-shape as seen in the X direction. Specifically, smoke exhaust duct 30 has a pair of walls 31 extending orthogonally to the Y direction. Smoke exhaust duct 30 also includes a top plate 32 connecting walls 31 of the pair. Top plate 32 extends orthogonally to the Z direction. In other words, top plate 32 extends along upper surface 10a of stack 10. Smoke exhaust duct 30 is open on the stack 10 side (Z2 side).

Accordingly, smoke discharged from gas-discharge valve 11b (see FIG. 2) provided in upper surface 11a of battery cell 11 is introduced into smoke exhaust duct 30. Smoke exhaust duct 30 allows the introduced smoke to flow in the X direction. Thus, the smoke introduced into smoke exhaust duct 30 is moved to a predetermined location.

Smoke exhaust duct 30 is made of an electrically insulating resin such as polyphenol or polypropylene, for example. The stiffness (Young's modulus) of smoke exhaust duct 30 is higher than that of a frame member 42 which is described later herein. In other words, smoke exhaust duct 30 is less likely to deform than frame member 42.

Referring again to FIG. 1, bus bar module 40 includes a plurality of bus bars 41, frame member 42, a flexible printed circuit (FPC) board 43, and a connector 44. Frame member 42 supports the plurality of bus bars 41.

Bus bar module 40 is provided so as to cover, from the Z1 side, at least a part (the entire surface, for example) of smoke exhaust duct 30. Each of the plurality of bus bars 41 is connected to stack 10 (positive electrode terminal 11c or negative electrode terminal 11d of battery cell 11).

Bus bar module 40 is placed on each of two stacks 10. While bus bar module 40 is shown in FIG. 1 as being placed on the Y1 side stack 10 only for the sake of convenience, actually bus bar module 40 is also placed on the Y2 side stack 10 as well.

In FIG. 1, a bus bar placement region 41a where a plurality of bus bars 41 are arranged in the X direction is indicated by a broken line. In FIG. 1, only two bus bars 41 are shown in bus bar placement region 41a for the sake of simplification.

The plurality of bus bars 41 (bus bar placement region 41a) are provided on each of one side (Y1 side) and the other side (Y2 side) of smoke exhaust duct 30 in the Y direction. Each of the plurality of bus bars 41 provided on the Y1 side of smoke exhaust duct 30 is an example of “first bus bar” in the present disclosure. Each of the plurality of bus bars 41 provided on the Y2 side of smoke exhaust duct 30 is an example of “second bus bar” in the present disclosure.

FPC board 43 is supported by frame member 42 (a frame central portion 42a described later herein), between the plurality of bus bars 41 on the Y1 side and the plurality of bus bars 41 on the Y2 side. FPC board 43 is electrically connected to each of the plurality of bus bars 41 on the Y1 side and the plurality of bus bars 41 on the Y2 side. Accordingly, the plurality of bus bars 41 on the Y1 side and the plurality of bus bars 41 on the Y2 side are connected in series. Connector 44 transmits information on the value of voltage of a plurality of battery cells 11 from FPC board 43, to an ECU (Electric Control Unit) (not shown) of a vehicle, for example.

Sponge 50 is placed on smoke exhaust duct 30. Specifically, sponge 50 is placed on an outer surface 32a of top plate 32 of smoke exhaust duct 30.

Sponge 50 includes sponges 51 placed respectively at both ends of smoke exhaust duct 30 in the X direction. Sponge 51 on the X1 side is provided at a position corresponding to the X1-side end of stack 10. Sponge 51 on the X2 side is provided at a position corresponding to the X2-side end of stack 10. Sponge 51 is an example of “end elastic body” in the present disclosure.

Sponge 50 also includes a sponge 52 placed at a position corresponding to a central portion, in the X direction, of stack 10 (placed at a central portion, in the X direction, of smoke exhaust duct 30). Two sponges 52 are provided on smoke exhaust duct 30. The number of sponges 52 may be one. Sponge 52 is an example of “central elastic body” in the present disclosure.

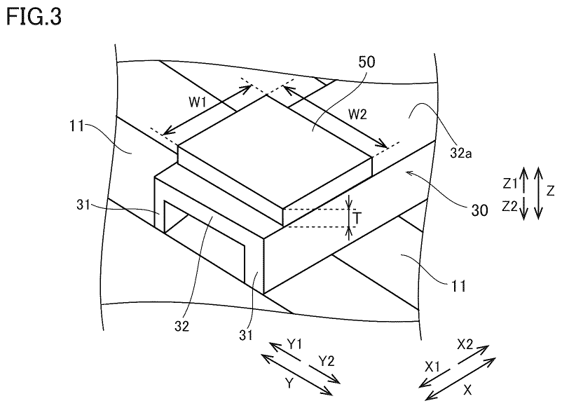

FIG. 3 is a partial enlarged view of sponge 50 and its periphery in FIG. 1. As shown in FIG. 3, sponge 50 has a flat plate shape. Sponge 50 has a thickness T in the Z direction. Sponge 50 has a width W1 in the X direction. Sponge 50 has a width W2 in the Y direction. Thickness T is smaller than each of width W1 and width W2. Width W1 and width W2 are substantially equal to each other.

Stack 10 is fit in accommodation hole 21 of die-cast case 20, and therefore compressed with a certain pressure in each of the X direction and the Y direction. Each of the plurality of battery cells 11 may be deformed to expand due to heat for example. Due to these factors, a force may act on each of the plurality of battery cells 11 of stack 10 to cause the cell to shift toward the Z1 side. In this case, stack 10 tends to be deformed into a wavy shape rising and falling in the Z direction. It is therefore desired to restrain the deformation of stack 10 in the Z direction while restraining increase of the number of parts.

In the present embodiment, sponge 50 is therefore placed between bus bar module 40 and smoke exhaust duct 30. Sponge 50 is pressed from the Z1 side by bus bar module 40, while being supported from the Z2 side by smoke exhaust duct 30. Accordingly, sponge 50 is compressed by smoke exhaust duct 30 and bus bar module 40.

The above configuration enables bus bar module 40 to press smoke exhaust duct 30 with sponge 50 interposed therebetween. As a result, stack 10 can be restrained from being deformed into a wavy shape rising and falling in the top-bottom direction (Z direction) by means of smoke exhaust duct 30 pressed by bus bar module 40. The deformation of stack 10 can be restrained by means of bus bar module 40, in contrast to the case where a separate member is provided for restraining deformation of stack 10. It is therefore possible to restrain stack 10 from being deformed in the top-bottom direction, while restraining increase of the number of parts. Further, stack 10 is pressed by smoke exhaust duct 30 having relatively high stiffness, and it is therefore possible to more effectively restrain the deformation of stack 10 in the Z direction.

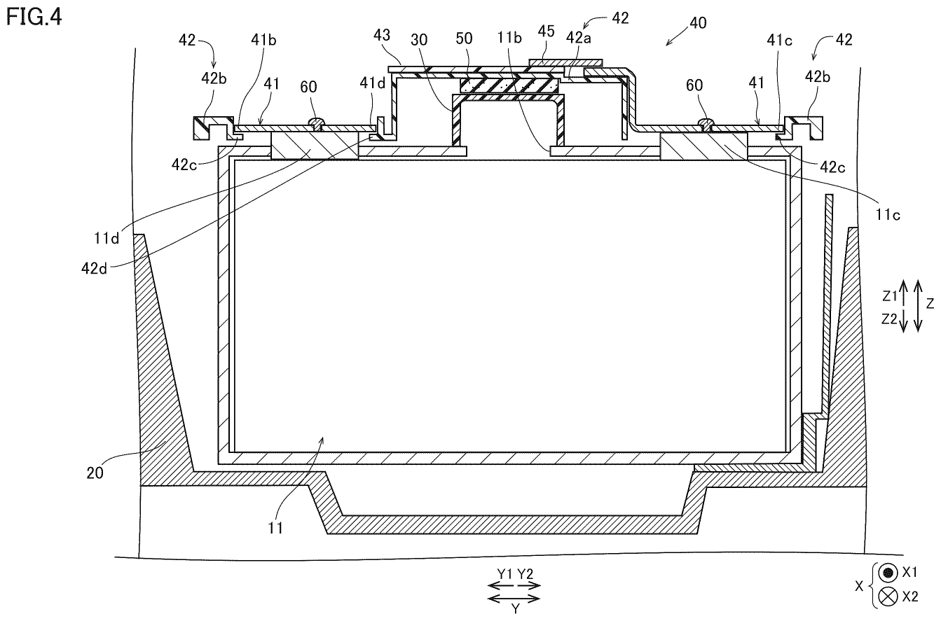

Specifically, as shown in FIG. 4, sponge 50 is pressed by frame member 42 of bus bar module 40. Frame member 42 includes a frame central portion 42a and a frame edge portion 42b. Sponge 50 is pressed by frame central portion 42a.

Frame central portion 42a is provided at a center, in the Y direction, of frame member 42. Frame edge portion 42b is provided at an outer peripheral edge of frame member 42. Frame central portion 42a is formed integrally with frame edge portion 42b.

Frame central portion 42a has a shape along smoke exhaust duct 30. Specifically, frame central portion 42a has a U-shape, similar to that of smoke exhaust duct 30, as seen in a cross-sectional view along the Y direction. A part of frame central portion 42a is placed to extend on the side (Z1 side) opposite to stack 10 with respect to sponge 50. Thus, frame central portion 42a is provided so as to cover at least a part of smoke exhaust duct 30.

Frame edge portion 42b is provided at each of the Y1-side end of frame member 42 and the Y2-side end of frame member 42. Frame edge portion 42b is provided with an engagement portion 42c that engages with bus bar 41. Engagement portion 42c of frame edge portion 42b provided on the Y1 side engages with a Y1-side end 41b of bus bar 41 on the Y1 side. Engagement portion 42c of frame edge portion 42b provided on the Y2 side engages with a Y2-side end 41c of bus bar 41 on the Y2 side. Engagement portion 42c is provided to support end 41b (41c) of bus bar 41 from the stack 10 side (Z2 side).

Frame central portion 42a is provided with an engagement portion 42d that engages with the plurality of bus bars 41. In the example shown in FIG. 4, engagement portion 42d engages with a Y2-side end 41d of bus bar 41 on the Y1 side. Engagement portion 42d is provided to support end 41d of bus bar 41 from the stack 10 side (Z2 side). Although not shown in FIG. 4, frame central portion 42a has an engagement portion 42d that engages with bus bar 41 on the Y2 side, at a position in the X direction different from that in FIG. 4.

Bus bar module 40 also includes a bus bar 45 provided to connect FPC board 43 and bus bar 41 to each other. In the example shown in FIG. 4, bus bar 45 is connected to FPC board 43 and bus bar 41 on the Y2 side. Thus, FPC board 43 and bus bar 41 are electrically connected to each other through bus bar 45.

Each of the plurality of bus bars 41 is bonded to battery cell 11 (positive electrode terminal 11c or negative electrode terminal 11d) with a solder 60. Bonding force applied between bus bar 41 and battery cell 11 by solder 60 causes engagement portion 42c (and engagement portion 42d) on the Y1 side and the Y2 side to be pressed (biased) toward stack 10 (Z1 side) by bus bar 41.

Frame central portion 42a and frame edge portions 42b are integrally formed. Therefore, when engagement portion 42c of frame edge portion 42b is pressed by bus bar 41, frame central portion 42a is drawn toward stack 10 (Z2 side). Further, engagement portion 42d of frame central portion 42a is pressed toward stack 10 by bus bar 41. Accordingly, sponge 50 is pressed toward stack 10 by frame central portion 42a.

Although not shown in FIG. 4, bus bar 45 is connected to each of bus bar 41 and FPC board 43 by a solder (not shown). Thus, frame central portion 42a is pressed (biased) toward stack 10 (Z1 side) by bonding force of the solder (not shown). Accordingly, sponge 50 is pressed toward stack 10 by frame central portion 42a.

As seen from the foregoing, the present embodiment places sponge 50 between bus bar module 40 and smoke exhaust duct 30. Thus, pressing force from bus bar module 40 to smoke exhaust duct 30 can be received by sponge 50. Accordingly, smoke exhaust duct 30 can be fixed by being pressed by bus bar module 40. In addition, sponge 50 makes it possible to restrain direct contact between bus bar module 40 and smoke exhaust duct 30. Accordingly, sponge 50 can cushion collision between bus bar module 40 and smoke exhaust duct 30.

While the above embodiment illustrates an example where sponge 50 is placed at each of the ends and the central portion, in the X direction, of smoke exhaust duct 30, the present disclosure is not limited to this. For example, sponge 50 may be placed only at one of the ends and the central portion, in the X direction, of smoke exhaust duct 30. That is, sponge 50 may be placed only at a position corresponding to the center of stack 10 in the X direction or only at a position corresponding to an end of stack 10 in the X direction.

Sponge 50 may also be placed at a position other than the ends and the central portion of smoke exhaust duct 30 in the X direction.

While the above embodiment illustrates an example where sponge 50 is pressed toward stack 10 by frame member 42 of bus bar module 40, the present disclosure is not limited to this. For example, sponge 50 may be pressed toward stack 10 by FPC board 43 or bus bar 41.

While the above embodiment illustrates an example where width W1 of sponge 50 in the X direction and width W2 of sponge 50 in the Y direction are substantially equal to each other, the present disclosure is not limited to this. For example, width W1 may be larger than width W2. For example, width W1 may be substantially equal to the length of smoke exhaust duct 30 in the X direction.

It should be noted that the features (processes) of the above embodiments and the above modifications may be combined with each other.

While embodiments of the present disclosure have been described, it should be construed that the embodiments disclosed herein are given by way of illustration in all respects, not by way of limitation. It is intended that the scope of the present disclosure is defined by claims, not by the description above, and encompasses all modifications and variations equivalent in meaning and scope to the claims.

What is claimed is:

1. A power storage device comprising:
a stack formed of a plurality of battery cells arrayed in an array direction;
a smoke exhaust duct placed on the stack and extending in the array direction;
a bus bar module including a plurality of bus bars connected to the stack; and
an elastic body placed on the smoke exhaust duct, wherein
the bus bar module covers at least a part of the smoke exhaust duct, and
the elastic body is placed between the bus bar module and the smoke exhaust duct.

2. The power storage device according to claim 1, wherein the elastic body includes a central elastic body placed at a position corresponding to a central portion, in the array direction, of the stack.

3. The power storage device according to claim 1, wherein the elastic body includes an end elastic body placed at an end, in the array direction, of the smoke exhaust duct.

4. The power storage device according to claim 1, wherein
the bus bar module includes a frame member supporting the plurality of bus bars,
the plurality of bus bars press the frame member toward the stack, and
at least a part of the frame member is placed to extend on an opposite side to the stack with respect to the elastic body to cover at least a part of the smoke exhaust duct.

5. The power storage device according to claim 4, wherein
the plurality of bus bars include a first bus bar located on one side of the smoke exhaust duct in a crossing direction crossing the array direction, and a second bus bar located on the other side of the smoke exhaust duct in the crossing direction, and
the first bus bar and the second bus bar each press the frame member toward the stack.
